(19) United States
(12) Patent Application Publication
(10) Pub. No.: US 2005/0066161 A1
(43) Pub. Date: Mar. 24, 2005

(54) Mail sever security login identification system and method with IC card identification hardware device

(76) Inventor: Hui Lin, Taipei (TW)

Correspondence Address: PRO-TECHTOR INTERNATIONAL, 20775 Norada Court, Saratoga, CA, 95070-3018, US

(21) Appl. No.: 10/937,235

(22) Filed: Sep. 8, 2004

(30) Foreign Application Priority Data
Sep. 19, 2003 (TW) 092125970

(51) Int. Cl. H04L 9/32; G06F 11/30

(52) U.S. Cl. 713/155; 713/182; 713/202

(57) ABSTRACT

Internet mails sever security login identification system and method, and particularly to an Integrated Circuit (IC) card identification hardware device of confirming login user's authentication. IC card device and within non-duplication code installed in computer via USB, PS2, wireless, or IR interface is using as identification hardware to set with mail server. Use non-duplication code in IC card and encryption system to ensure user authentication and data confidentiality on Internet or any other information system of computer. As using normal private key the invention is easy and convenient to use.

### BACKGROUND OF THE INVENTION

1. Field of the Invention

The present invention relates to an Internet mail sever security login identification system and method, and particularly to an Integrated Circuit (IC) card identification hardware device of confirming login user's authentication

2. Description of the Related Art

In the global keen competition commercial environment, e-mail is a main powerful tool of information communication and commercial contact. It used even 70% source of commercial network, and increase in 5 times each year. According to the CNET magazine, to the end of 2001, the count of e-mail addresses was over a billion. Estimate that there were average 20 to 30 mails in one mailbox each day, so billions of e-mails are transmitted over all kinds of networks everyday. It is thus clear that the importance of e-mail on Internet.

Old traditional Simple Mail Transfer Protocol (SMTP) cannot identify users' identities, so it was easy to be used as a transferring point to send spam (unsolicited commercial or garbage e-mails) by crackers. A mail transferring mechanism with no identification also cause problem for system operators (SYSOP) to trace the spam. To avoid this problem, most mail system only serve users in local or authentic area to deny outside mail relay. But in this case the limitation also cause inconvenient to authentic users. For example, after you leave the office or school, you cannot use the mail server in the company or school to send a mail. In the past only some few expensive commercial mail server can identify users' identities when sending mails, but via this invention, plus a Certification Authority (CA) server, can provide an effective protection and identification.

The well-known method to identify any kinds of member function, including login a mail server, works by setting passwords by users or given users a random one by server. With authentic ID and password a user can login the server and use this identity to get any service that server provide, even read some private data or records. Even using some coding technique on the server also cannot prevent the attack by crackers to make sure the safety of data. And for convenient reason, many services provide all over the Internet so that users can use them everywhere. But this also causes illegal using and difficult to trace if they leave the password on the public computer or divulge by back door computer program (virus). These illegal using may also cause users' loss.

In modern time, most crackers often use “Dictionary Attack” to crack legal users' password, so the simple security method by confirming a user's ID and password is not secure, because:
1. Most password are only choice for easy to memorize, not many users use a series random letters and numbers as password. A master of cryptography Daniel Klein believes that “Dictionary Attack” can easily crack more than 40% passwords. There are also many password crack software made by crackers or system professionals on the Internet as a tool for invasion.
2. The information system and network is getting more and more complex; many different systems are connected by network. Thus when a user sign into different systems, due to requirement of each system, a user has to login many times with password(s). According to a statistics, only few users can memorize 3 different sets of 8 characters length passwords. The conclusion is, most users write down the password and store in a convenient place. Obviously, that also becomes a weak point of security.
3. Even without above two weaknesses, but still, a password transfer from 10 the client to server in plain code. A cracker can easily intercept the password at everywhere on the Internet or Local Area Network (LAN), then can fake (Replay) to invade the target system. Even using a dedicated line still switch in a public switch system. For a cracker, that's easier to invade because information on the line is often routine so he can concentrate to intercept on the dedicated line.

On the Internet, the communication protocol TCP/IP is used. Two computers on the network should make a Three-way Handing Shaking to set up a connection to transfer data. But this gives a chance to a hidden cracker, because:
1. Information transfer via public Internet is in plain code. Any computer connecting to the Internet can monitor (Sniffing) information that transfers on the network. Thus all the privates and commercial secrets will expose on Internet.
2. To fake user's identity to access remote server, a cracker will also fake as the server to reply mass useless information to user, attempt to tie up operation of client computer (Denial of Service; DoS). A cracker can not only fake a user's identity to access remote service, issue, change, or delete user's data with no aware. And the true user even could not deny that the change was done by himself.

Further, when user connects Internet on public computer, the connection is via LAN to Internet. On LAN, Ethernet-based IP network for example, data (Packet) is broadcasting to all PC on LAN. Crackers can intercept data on LAN easily because:
1. Data (Packet) is broadcasting to all PC on LAN in plain code, thus all PC connected on LAN can play a monitor role (Sniffer) to steal others' data.
2. And the worse is, once a password is cracked, system could be unauthorized signed into and changed data, spread fake messages, steal or delete information for commercial or noncommercial reasons . . . etc.

For above problems, the Internet security leak should be mend. One identity confirmation process should be set for double check except for only password.

### SUMMARY OF THE INVENTION

To solve the problems description above, this present invention discloses a method of installing identification hardware within an IC card and setting with a CA server (security mechanism) to satisfy below 5 requirements of information security of electronic data transferring on network:

1. Confidentiality:
To make sure information may not be peeped or stolen by a third party to protect users' privacy. This can be done by encryption.

2. Integrity:
To make sure information may not be tampered by a third party to protect correctness of data. This can be done by digital signature or encryption.

3. Authentication:
To make sure the source of transferring information may not be faked. This also can be done by digital signature or encryption.

4. Non-repudiation:
With digital signature or encryption prevent a user's denying of access.

5. Access Control:
Limit users' authority according to identities.

As described above, an IC card device within an Integrated Circuit Card Identification (ICCID) and a Global Number (GLN) is used. With an IC card reader apparatus installed in a compatible Universal Serial Bus (USB), Public Switched 2 (PS2) interface or other wireless, infrared (IR) hardware is as an identification device. When a user login his username and password to access mail server with the IC card identification hardware device installed in the computer, a program installed within the IC card will make a login process to a CA server to decode the ICCID, compare with the CA identification database, produce an authorized (Validate=Y) EKI value, then decode the value to a KI value and calculate a random value. CA server will encrypt and store KI as the hardware identification successful verification (Server Result). This result can also record the accesses of a user, confirm legitimacy and limits of authority of login mail server of ICCID. When hardware satisfy identification, CA server will send result random value to IC card, and once IC card receive this random value, within program will decode its ICCID to a KI, then encrypt KI and the random value from CA server to result verification (Client Result) for cross-comparing by mail server and CA server. If an IC card fails in cross-comparing of authorization (Validate=N), user will be told by system that login failed.

Mail server will receive ICCID, Client Result, username, and password when above process is success, then compare login username and password with its database and check avail date first. If correct, mail server will submit ICCID and Client Result to CA server to decrypt and compare with foregoing Server Result. If all matched, user can be confirmed as a legal registrant, and last Server Result will be cleared for next login. If not matched, CA sever will send back a failed message to mail server to reject access.

As described above, but crackers can only intercept a changed random value produced from CA server on the network. This value cannot be used as a valid login next time.

The User, mail server, and CA server in this identification system and method form a circle frame. No further process is required for users when login but only an added small program running in login page of mail server. The IC card is the only key belonged to user as valid verification, with a compliant IC card reader work just simple like key and lock. ICCID was burned as firmware in the chip of IC card. IC card and reader can made compliant to USB, PS2, wireless, or IR hardware. They can also set with storage device like flash memory.

### BRIEF DESCRIPTION OF THE DRAWINGS

FIG. 1 is a diagram illustration the operation procedure of the present invention;

FIG. 2 is a diagram showing apparatuses that IC card device can couple with;

FIG. 3 is a diagram illustration the login process of the present invention;

FIG. 4 is a diagram showing embodiment of the IC card device;

FIG. 5 is a diagram showing embodiment of the IC card device in PCMCIA interface apparatus;

FIG. 6 is a diagram showing alternative embodiment of the IC card device integrated with flash memory; and

FIG. 7 is a diagram illustration IC card device integrated flash memory plugged into computer chassis to practice of the present invention.

### DETAILED DESCRIPTION OF THE PREFERRED EMBODIMENTS

In the following description, refers to the drawings.

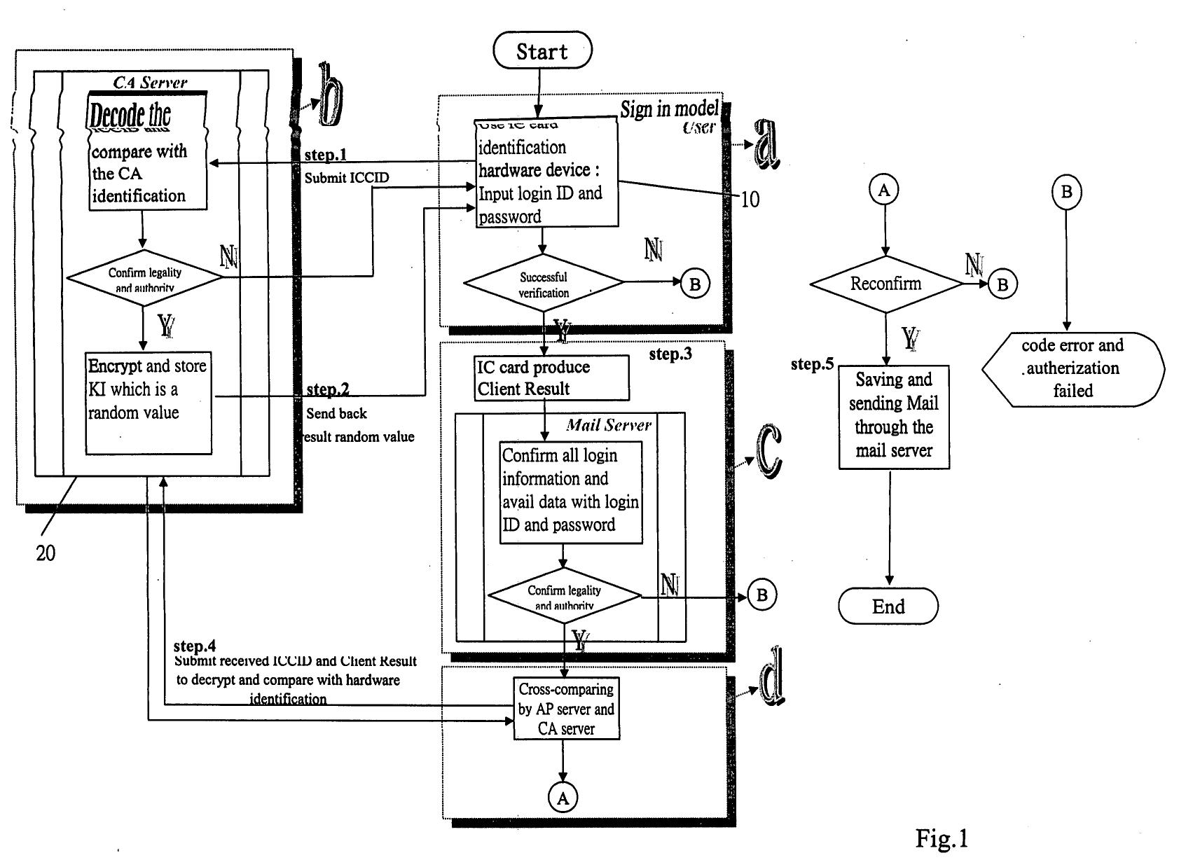

FIG. 1 illustrates procedures of flow sheet of this invention, comprises a, b, c, d four main processes and five procedures from step 1 to step 5 of legal login process.
Process a: Use IC card identification hardware device comprised an IC card and its reader to login mail server. Input login ID and password, then submit.
Process b: IC card transfers login process and ICCID to CA server (step 1). CA server will decode ICCID and compare with its database, confirm legality and authority of ICCID. If it's confirmable, CA server will record in its database and calculate a Server Result, which is a random value, then report this value to IC card (step 2).
Process c: When process b is confirmed, IC card will calculate with random value from CA server and ICCID to a Client Result (step 3), transfer process, ICCID, and Client Result to mail server. With login ID and password, mail server will confirm all login information and avail date.
Process d: When process c is confirmed, mail server will submit received ICCID and Client Result to CA server to decrypt and compare with hardware identification.

For further description below, in process a, a user inserts an IC card, which has within ICCID and GLN code, into a card reader apparatus, which is installed in USB-compliant, PS2 interface or other wireless, IR apparatus as identification hardware device. Using this hardware device to open login process of mail server and then submit login ID and password.

In process b, when user submits ID and password, within program in IC card will transfer ICCID code to CA server. CA server will decode the ICCID, compare with the CA identification database, produce an authorized (Validate=Y) EKI value, then decode the value to a KI value and calculate a random value, encrypt and store KI as the hardware identification successful verification (Server Result). This result can also record the accesses of a user, confirm legitimacy and limits of authority of login mail server of ICCID. When hardware satisfies identification, CA server will send result random value to IC card as a key value. If an IC card fails in cross comparing of authorization (Validate=N), user will be told by system that login failed.

If pass process b, then go to process c. Mail server will receive key value and ICCID code of IC card, and submitted login information, then confirm the information and avail date.

In process d, when process c confirmed, mail server will send received key and ICCID code to CA server for further confirming. CA server will first decode ICCID, and compare with its database. If this ICCID has a relative valid EKI, use the key value to decode EKI to compare with Server Result. If matched, user can authorized login mail server and CA server will clean out its Server Result for next use. If not matched, CA server will tell mail server ICCID code error and authorization failed.

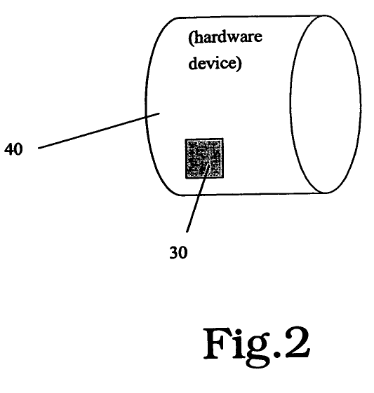

FIG. 2 illustrates exemplary hardware device that could be used to implement the present invention. IC card 30 is burned as firmware into chip. It's hard to fake and copy. Identification hardware 40 is as IC card 30 reader apparatus, which can use compatible to USB, PS2 interface, wireless communication device, or use as storage medium.

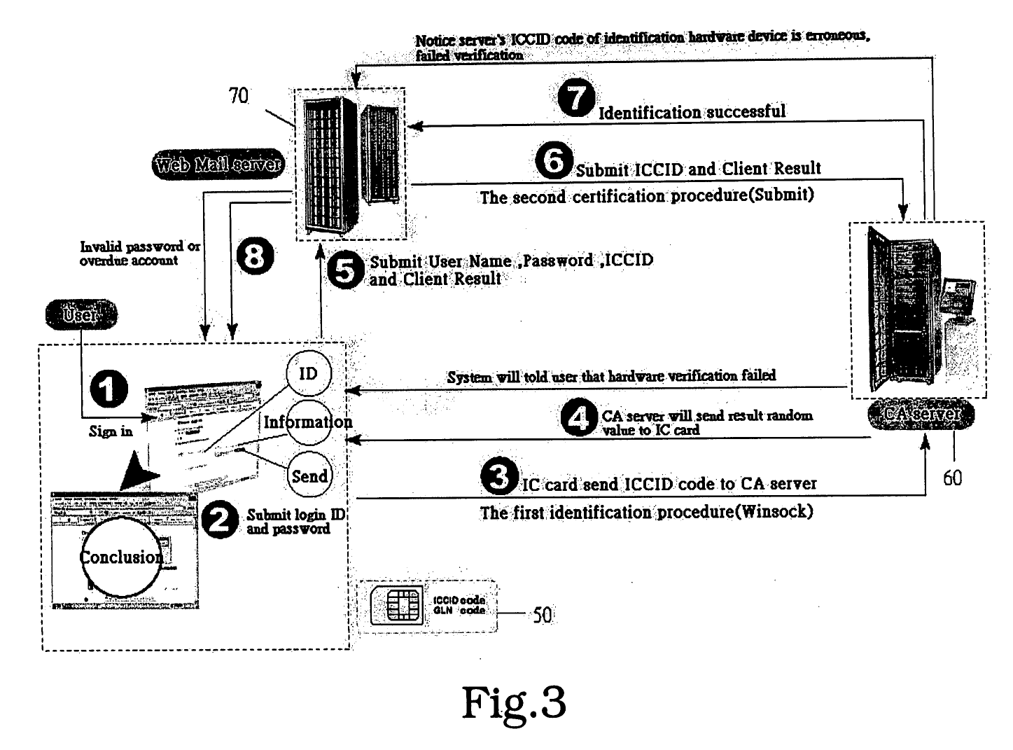

FIG. 3 illustrates substantiation of the present invention. The actual login operation procedure, from submitting to authorization, contains totally 8 routes. Route 1 indicates a user using identification hardware (with IC card) 50 installed in client computer to login mail server 70. In route 2 a user submit login ID and password in login window (can be a web page). This will act on route 3, which IC card within program will guide login procedure to CA server 60. Route 3 is the first identification procedure (Winsock) of the prevent invention. In this process CA server 60 will compare ICCID code and calculate a Server Result. When hardware identification is confirmed, it will lead route 4. In route 4 when IC card receive random value produced form CA server 60, it will calculate and encrypt to a Client Result. This Client Result will be used to compare for mail server in second certification procedure.

When first certification procedure successes, then it will go to route 5. Mail server 70 will receive ICCID code, Client Result, and username and password submitted by user who login. If submitted data is correct, route 6, which is proceeding second certification procedure, will send ICCID code and Client Result back to CA server 60 to confirm with Server Result. If pass, route 7 will go in CA server 60 to tell mail server 70 certification confirmed. After double check to make sure user is legal, mail server 70 can login to access, and the final route 8 will go to clean up Server Result in CA server 60. If failed in route 6, mail server 70 will receive a message of ICCID error from CA server 60 and deny to access.

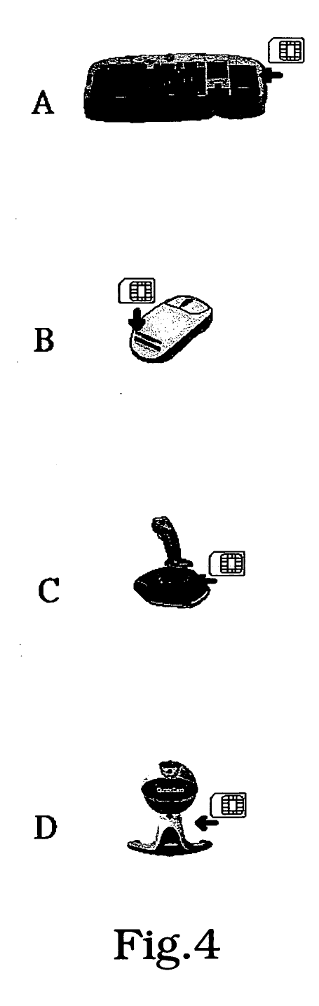

FIG. 4 is a diagram showing exemplary hardware devices for practicing the presenting invention. Besides directly installed in computer via USB, PS2 interface, or wireless, IR hardware device, IC card reader apparatus can also set within keyboard (A), mouse (B), joystick (C), or even web camera (Web Cam, D) to materialize hardware identification.

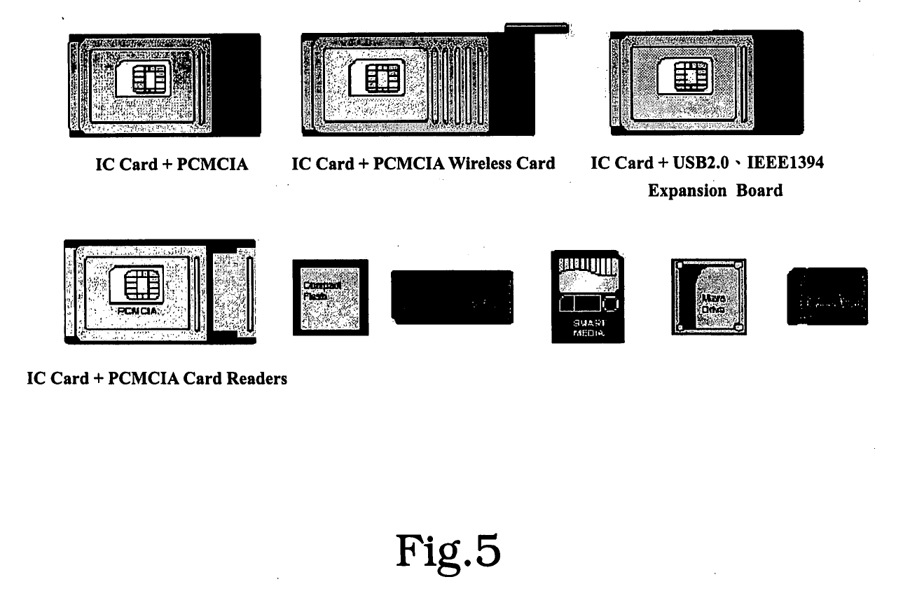

FIG. 5 is a diagram showing IC card reader device set on PCMCIA (Personal Computer Memory Card International Association) interface apparatus, as application of mobile notebook.

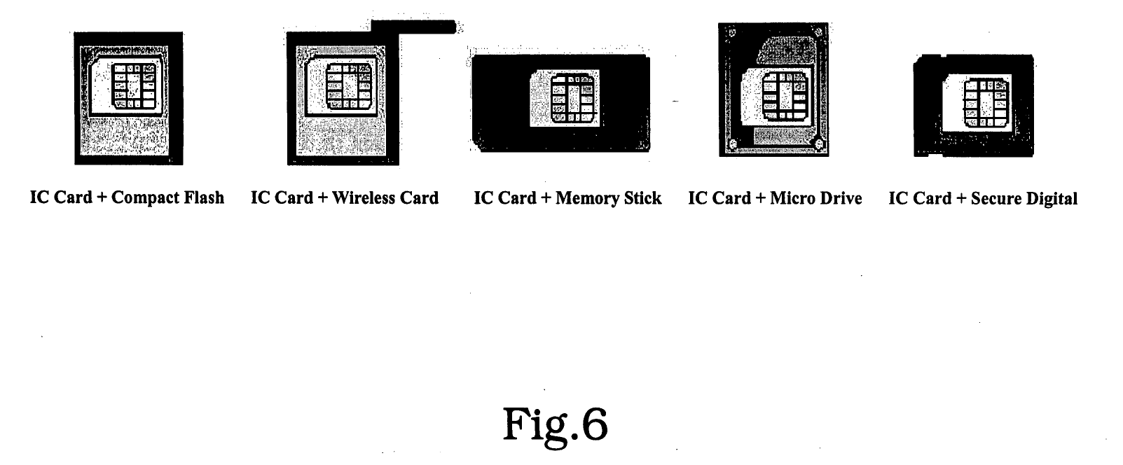

FIG. 6 is a diagram showing IC card device set with flash memory. This combined set can storage and keep also security, mobility, and privacy of data.

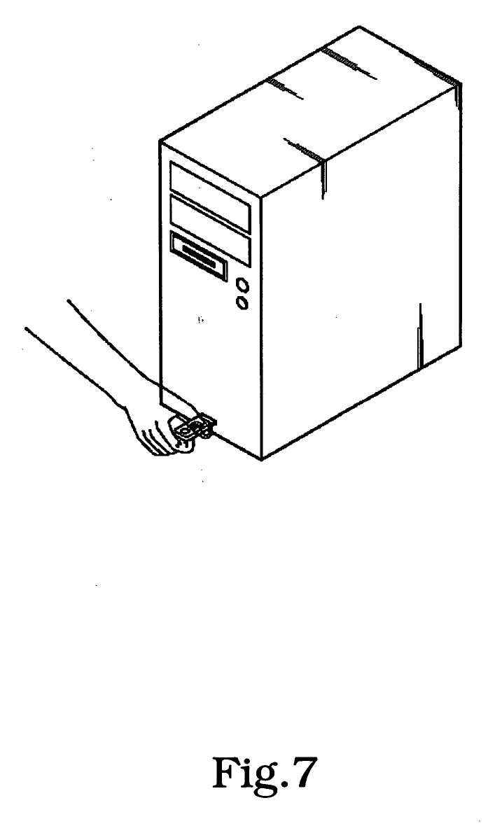

FIG. 7 is foregoing flash memory and IC card device integrated apparatus plug into computer. Using USB interface device can easily access and work.

The present invention can provide highly standard class security of mail system on Internet by many encryptions and cross confirming double check system. The IC card identification hardware device can use as a private verification key to access not only on Internet but also many information systems of computer. The foregoing describing of the preferred embodiment of the invention is for the purposes of illustration and description. It is not intended to exhaustive or to limit the invention to the precise from disclosed. Many other possible modifications and variations can be made without departing from the scope of the present invention, which following claims are depended.

1. A mail server security login identification system and method with IC card identification hardware device, using a IC card within ICCID and GLN, and a IC card reader apparatus installed in a computer as identification hardware device, comprising operation processes:
Process a: Use IC card identification hardware device comprised an IC card and its reader to login mail server. Input login ID and password, then submit;
Process b: IC card transfers login process and ICCID to CA server (step 1). CA server will decode ICCID and compare with its database, confirm legality and authority of ICCID. If it's confirmable, CA server will record in its database and calculate a Server Result, which is a random value, then report this value to IC card (step 2);
Process c: When process b is confirmed, IC card will calculate with random value from CA server and ICCID to a Client Result (step 3), transfer process, ICCID, and Client Result to mail server. With login ID and password, mail server will confirm all login information and avail date;
Process d: When process c is confirmed, mail server will submit received ICCID and Client Result to CA server to decrypt and compare with hardware identification;

2. The mail server security login identification system and method with IC card identification hardware device of claim 1, wherein the IC card identification hardware device is USB-compliant interface apparatus.

3. The mail server security login identification system and method with IC card identification hardware device of claim 1, wherein the IC card identification hardware device is PS2-compliant interface apparatus.

4. The mail server security login identification system and method with IC card identification hardware device of claim 1, wherein the IC card identification hardware device is wireless communicable interface apparatus.

5. The mail server security login identification system and method with IC card identification hardware device of claim 1, wherein the IC card identification hardware device is IEEE1394-compliant (Institute of Electrical and Electronic Engineers) interface apparatus.

6. The mail server security login identification system and method with IC card identification hardware device of claim 1, wherein the IC card identification hardware device is IR communicable interface apparatus.

7. The mail server security login identification system and method with IC card identification hardware device of claim 1, wherein the IC card identification hardware device is flash memory.

8. The mail server security login identification system and method with IC card identification hardware device of claim 1, wherein the IC card identification hardware device is PCMCIA-compliant interface apparatus.

9. The mail server security login identification system and method with IC card identification hardware device of claim 1, wherein the IC card identification hardware device is keyboard.

10. The mail server security login identification system and method with IC card identification hardware device of claim 1, wherein the IC card identification hardware device is mouse.

11. The mail server security login identification system and method with IC card identification hardware device of claim 1, wherein the IC card identification hardware device is joystick.

12. The mail server security login identification system and method with IC card identification hardware device of claim 1, wherein the IC card identification hardware device is Web Cam.
